(19) United States
(12) Patent Application Publication
(10) Pub. No.: US 2018/0129868 A1
(43) Pub. Date: May 10, 2018

(54) SYSTEM AND METHOD ASSOCIATED WITH OBJECT VERIFICATION

(71) Applicant: QUALCOMM Incorporated, San Diego, CA (US)

(72) Inventors: Michel Adib Sarkis, San Diego, CA (US); Yingyong Qi, San Diego, CA (US)

(21) Appl. No.: 15/346,343

(22) Filed: Nov. 8, 2016

(51) Int. Cl. G06K 9/00

(52) U.S. Cl. CPC G06K 9/00288; G06K 9/00268

(57) ABSTRACT

An apparatus includes a processor and a memory. The processor is configured to execute instructions stored at the memory to receive first characterization data and second characterization data. The first characterization data includes first values in a first order and corresponding to a first object. The second characterization data includes second values in a second order and corresponding to a second object. The processor is further configured to generate third characterization data and to generate fourth characterization. The third characterization data includes the first values in a third order. The fourth characterization data includes the second values in a fourth order. The processor is also configured to perform a first similarity operation using the first, second, third, and fourth characterization data to generate first result data and to determine whether the first object and the second object match based on the first result data.

### I. FIELD

The present disclosure is generally related to object verification.

### II. DESCRIPTION OF RELATED ART

Automated face verification is used in many applications. For example, a system or device may capture an image of an individual and compare the image to one or more images of authorized users to determine whether the individual is one of the authorized users. As another example, a system or device may automatically tag an image with metadata based on recognizing a face of the individual in the image. Tagging the image may enable the image to be returned in response to a search for images of the tagged individual. Although face verification techniques may be useful, they may be computationally complex and take several seconds to complete.

### III. SUMMARY

In a particular aspect, an apparatus includes a processor and a memory coupled to the processor. The memory includes instructions that, when executed by the processor, cause the processor to receive first characterization data and second characterization data. The first characterization data includes a plurality of first values in a first order and corresponding to a first object associated with a first image. The second characterization data includes a plurality of second values in a second order and corresponding to a second object associated with a second image. The instructions further cause the processor to generate third characterization data based on the first characterization data and to generate fourth characterization data based on the second characterization data. The third characterization data includes the plurality of first values in a third order. The fourth characterization data includes the plurality of second values in a fourth order. The instructions further cause the processor to perform a first similarity operation using the first characterization data, the second characterization data, the third characterization data, and the fourth characterization data to generate first result data. The instructions also cause the processor to determine whether the first object and the second object match based on the first result data.

In another particular aspect, a method includes receiving first characterization data and second characterization data. The first characterization data includes a plurality of first values in a first order and corresponding to a first object associated with a first image. The second characterization data includes a plurality of second values in a second order and corresponding to a second object associated with a second image. The method further includes generating third characterization data based on the first characterization data and generating fourth characterization data based on the second characterization data. The third characterization data has the plurality of first values in a third order and the fourth characterization data has the plurality of second values in a fourth order. The method also including performing a first similarity operation using the first characterization data, the second characterization data, the third characterization data, and the fourth characterization data to generate first result data. The method further including determining whether the first object and the second object match based on the first result data.

In another particular aspect, an apparatus includes means for receiving first characterization data and second characterization data. The first characterization data includes a plurality of first values in a first order and corresponding to a first object associated with a first image. The second characterization data includes a plurality of second values in a second order and corresponding to a second object associated with a second image. The apparatus further includes means for generating third characterization data based on the first characterization data and for generating fourth characterization data based on the second characterization data. The third characterization data has the plurality of first values in a third order and the fourth characterization data has the plurality of second values in a fourth order. The apparatus also includes means for performing a first similarity operation using the first characterization data, the second characterization data, the third characterization data, and the fourth characterization data to generate first result data. The apparatus further includes means for determining whether the first object and the second object match based on the first result data.

In another particular aspect, a non-transitory computer-readable medium comprises instructions that, when executed by a processor, causes the processor to receive first characterization data and second characterization data. The first characterization data includes a plurality of first values in a first order and corresponding to a first object associated with a first image. The second characterization data includes a plurality of second values in a second order and corresponding to a second object associated with a second image. The instructions further cause the processor to generate third characterization data based on the first characterization data and to generate fourth characterization data based on the second characterization data. The third characterization data has the plurality of first values in a third order and the fourth characterization data has the plurality of second values in a fourth order. The instructions also cause the processor to perform a first similarity operation using the first characterization data, the second characterization data, the third characterization data, and the fourth characterization data to generate first result data. The instructions further cause the processor to determine whether the first object and the second object match based on the first result data.

Other aspects, advantages, and features of the present disclosure will become apparent after review of the application, including the following sections: Brief Description of the Drawings, Detailed Description, and the Claims.

### IV. BRIEF DESCRIPTION OF THE DRAWINGS

FIG. 1 is a block diagram of an example of a system for object verification;

FIG. 2 is a diagram of an example of a process for object verification;

FIG. 3 is a diagram of an illustrative process of generating metric data for object verification;

FIG. 4 is a diagram of an illustrative process of generating similarity score data for object verification;

FIG. 5 is a flow chart illustrating an example of a method of object verification;

FIG. 6 is a flow chart illustrating an example of a method of generating metric data for object verification; and

FIG. 7 is a block diagram of a particular illustrative example of a device that is operable to perform object verification.

### V. DETAILED DESCRIPTION

Particular implementations of the present disclosure are described below with reference to the drawings. In the description, common features are designated by common reference numbers throughout the drawings. As used herein, various terminology is for the purpose of describing particular implementations only and is not intended to be limiting of implementations. For example, the singular forms “a,” “an,” and “the” are intended to include the plural forms as well, unless the context clearly indicates otherwise. It may be further understood that the terms “comprises” and “comprising” may be used interchangeably with “includes” or “including.” Additionally, it will be understood that the term “wherein” may be used interchangeably with “where.” As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

The present disclosure describes systems and methods for determining whether objects (e.g., faces) in two different images match. For example, first image data corresponding to a first face may be compared to second image data corresponding to a second face to determine whether the two faces are sufficiently similar to be identified as being the same person. To illustrate, first characterization data, such as a first vector of values, that is descriptive of the first image (e.g., the first face) may be compared to second characterization data, such as a second vector of values, that is descriptive of the second image (e.g., the second face) to generate similarity data (e.g., a similarity data set). The similarity data may include values that indicate a similarity (or a difference) between the first image (e.g., the first face) and the second image (e.g., the second face).

The values included in the similarity data may be determined by performing one or more element-wise operations on the first and second characterization data. For example, a first element-wise similarity operation (e.g., an element-wise absolute difference operation) may be performed to generate first result data and a second element-wise operation (e.g., an element-wise product operation) may be performed to generate second result data. The first result data and the second result data may be combined (e.g., concatenated) to generate the similarity data. In some implementations, each of the first element-wise operation and the second element-wise operation may be considered “symmetric” because each element-wise operation may include a “flipped” version of the first characterization data (e.g., a version having the first vector of values in reverse order) and a flipped version of the second characterization data. By including the flipped versions, the first and second element-wise operations may account for situations where a mirrored view of an object (e.g., a face) or a partial view of the object (e.g., a profile view) is included in an image.

A similarity score may be determined using the similarity data and metric data. For example, the similarity data and metric data may be used in a dot product operation to determine the similarity score. The first object and the second object may be considered a “match” if the similarity score is greater than or equal to a threshold.

The metric data may be determined according to a multi-layer quasi-gradient boost methodology. For example, the metric data may be calculated using a layered approach in which a first layer corresponds to individual landmarks (or patches) associated with an object and a second layer corresponds to an entirety of an object (or image). To illustrate, a similarity matrix may be generated based on multiple similarity data sets. Each of the similarity data sets may be generated based on two corresponding training images that include a matching object. For example, each similarity data set may be generated as described above with reference to the similarity data.

The similarity matrix may be divided into multiple portions, where each portion of the multiple portions includes at least one value from each of the similarity data sets. For example, a first portion may include at least one value from each similarity data set that is associated with a mouth of a face. During a first layer of processing, for each portion, a corresponding portion match score may be determined based on the portion and a match indicator value. The match indicator value may have a value that indicates that each similarity data set is based on images having matching objects. The portion match scores (e.g., a plurality of portion match scores) may be averaged together to determine an average match score of the plurality of portion match scores. During a second layer of processing, the metric value may be determined based on the average match score, the similarity matrix, and the match indicator value.

Element-wise operations may be less computationally complex and therefore faster to execute as compared to other techniques for generating similarity data. By using symmetric element-wise operations, the techniques described herein may more accurately determine that the first object and the second object match when the first image and the second image depict the same object from different angles or perspectives. The multi-layered gradient boost technique may generate metric data that leads to more accurate object verification as compared to other conventional techniques of determining whether two objects match. Further, performing a dot product operation using the similarity data and the metric data to obtain the similarity score may be less computationally complex than other conventional techniques of determining a similarity score. Thus, the described techniques may be faster (e.g., less computationally complex), more accurate, or both, as compared to other conventional techniques of object verification (e.g., probabilistic elastic part (PEP) modeling; hierarchical PEP modeling; or techniques based on scale-invariant feature transform (SIFT), Gaussian mixture models (GMMs), and Fisher vectors).

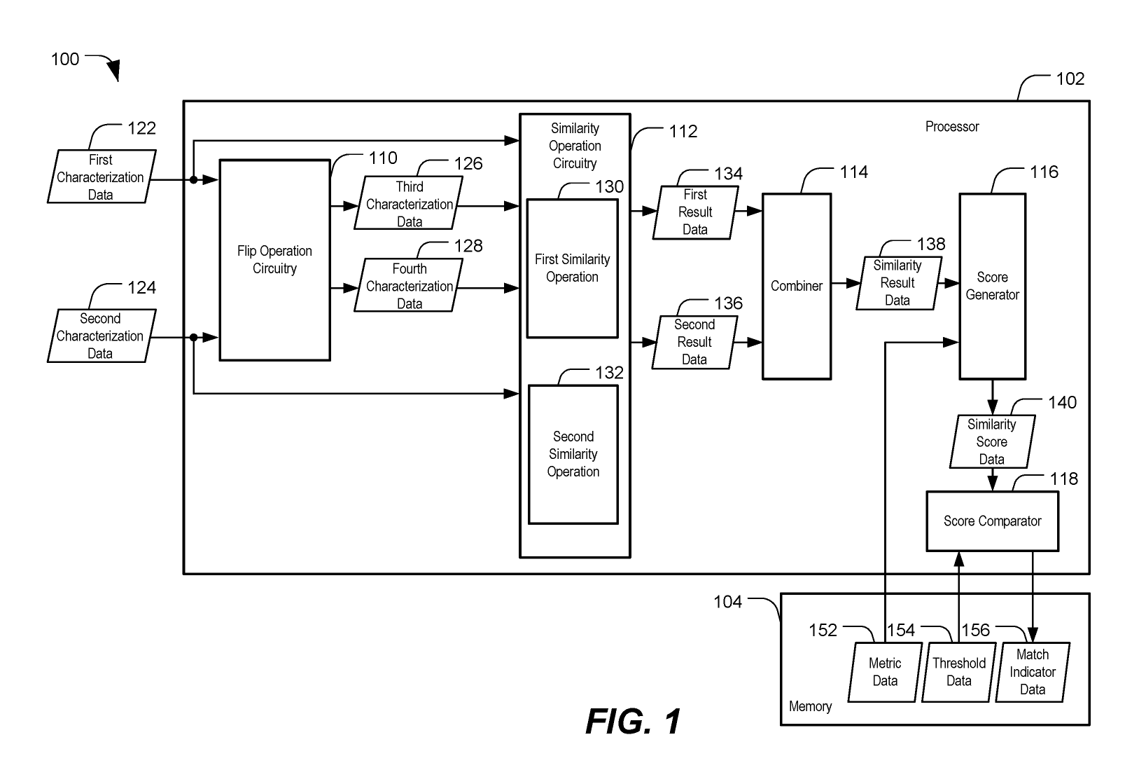

Referring to FIG. 1, a system 100 for object verification is shown. In particular examples, the system 100 may be capable of determining whether two faces depicted in two images belong to the same person. The system 100 includes a processor 102 and a memory 104. In particular examples, the processor 102 may include a central processor unit (CPU) or another type of processor. The memory 104 (e.g., a computer-readable medium) may include volatile memory, such as a random access memory device, non-volatile memory, or a combination thereof. In some examples, one or both of the processor 102 and the memory 104 is integrated into a computing device, such as a mobile device.

The processor 102 includes flip operation circuitry 110, similarity operation circuitry 112, a combiner 114, a score generator 116, and a score comparator 118. Each of the flip operation circuitry 110, the similarity operation circuitry 112, the combiner 114, the score generator 116, and the score comparator 118 may correspond to dedicated hardware components of the processor 102, to multi-purpose components of the processor 102 executing instructions stored in the memory 104, or a combination thereof.

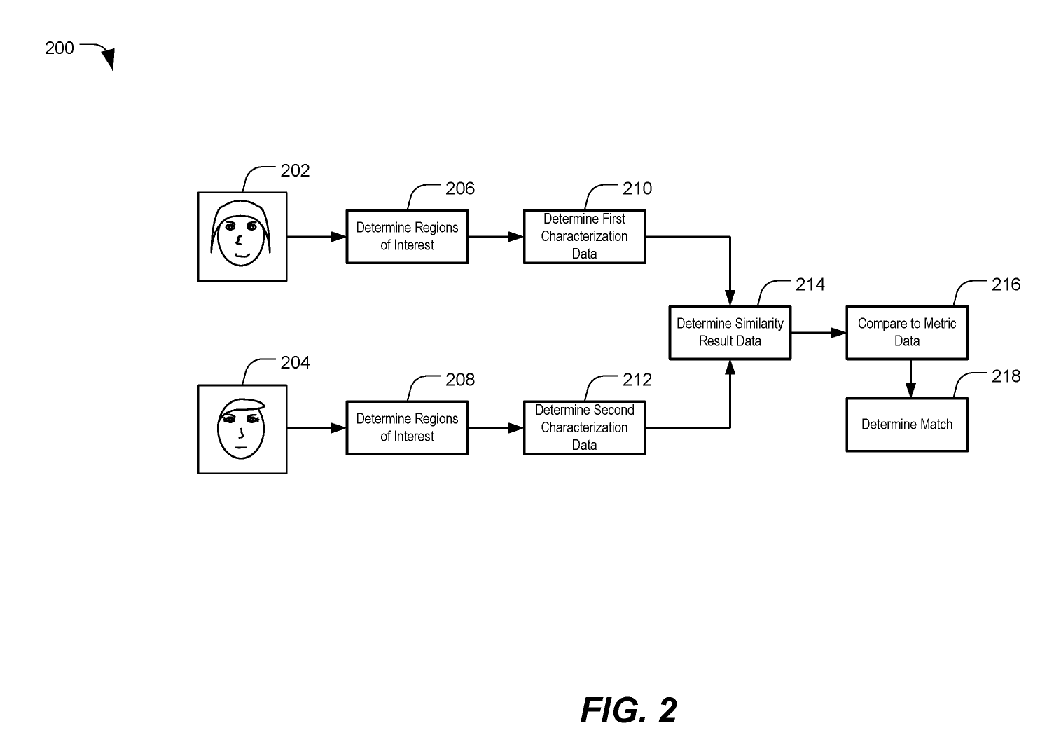

In operation, the flip operation circuitry 110 receives first characterization data 122 and second characterization data 124. The first characterization data 122 may include a plurality of first values in a first order corresponding to a first object associated with (e.g., depicted in) a first image. To illustrate, the first characterization data 122 may include a first vector having values descriptive of the first object, such as a first face, depicted in the first image. The second characterization data 124 may include a plurality of second values in a second order corresponding to a second object associated with (e.g., depicted in) a second image. To illustrate, the second characterization data 124 may include a second vector having values descriptive of the second object, such as a second face, depicted in the second image. In some examples, the processor 102 may receive data corresponding to the first image and the second image and calculate the first characterization data 122 and the second characterization data 124, as described with reference to FIG. 2. In other examples, the processor 102 may receive the first characterization data 122 and the second characterization data 124 from another source (e.g., another computing device), such as an object detection circuit coupled to the processor 102.

The values of the first characterization data 122 and the values of the second characterization data 124 may each be indexed according to an index value i. The first characterization data 122 and the second characterization data 124 may be arranged according to the same scheme, such that each element i=(1, 2, 3 . . . ) of the first characterization data 122 and the corresponding element i=(1, 2, 3 . . . ) of the second characterization data 124 describe the same portion of the object (or the image). To illustrate, element i=1 of the first characterization data 122 may describe a color of a left eye depicted in the first image and element i=1 of the second characterization data 124 may describe a color of a left eye depicted in the second image.

In a first illustrative example, each value of the first characterization data 122 and the second characterization data 124 corresponds to a particular portion of a face. To illustrate, a first particular value at a particular index in the first characterization data 122 may describe a first feature at a landmark of the first face, and a second particular value at the particular index in the second characterization data 124 may describe a second feature at the landmark of the second face. A landmark may include a nose, a mouth, a right eye, a left eye, a chin, a left corner of an eye, or any other identifiable portion of a face. A feature value may describe the landmark. To illustrate, a feature value may indicate a direction of a wrinkle, a color value, a distance from another landmark, or some other feature. In some examples, more than one value may correspond to a particular landmark. For example, a plurality of values may describe the same landmark at different resolutions. For example, elements i=1 to i=3 may correspond to a color of a left eye. Element i=1 may correspond to a value indicating the color of the left eye as determined at a 2×2 pixel resolution. Element i=2 may correspond to a value indicating the color of the left eye as determined at a 3×3 pixel resolution. Element i=3 may correspond to a value indicating the color of the left eye as determined at a 4×4 pixel resolution. Thus, the first particular value may indicate a first color of a left eye of the first face and the second particular value may indicate a second color of a left eye of the second face.

In a second illustrative example, each value of the first characterization data 122 and the second characterization data 124 corresponds to a particular portion (e.g., a patch) of an image. To illustrate, a first particular value at a particular index in the first characterization data 122 may describe a characteristic of a first patch in the first image, and a second particular value at the particular index in the second characterization data 124 may describe a second characteristic of a second patch in the second image. The first patch and the second patch may be located at the same or similar coordinates within the first image and the second image, respectively. A characteristic value may indicate a pixel color, an average pixel intensity, or some other characteristic associated with a patch. In some examples, patches described by characterization data may overlap. For example, a plurality of patches may be centered on the same pixel coordinates. Each of the plurality of patches may be sized differently. Thus, an element i=1 of the first characterization data 122 may describe a 3×3 patch of the first image centered at coordinates x, y, and an element i=2 of the first characterization data 122 may describe a 5×5 patch of the first image centered at the coordinates x, y. An element i=1 of the second characterization data 124 may describe a 7×7 patch of the second image centered at the coordinates x, y, and an element i=2 of the second characterization data 124 may describe a 3×3 patch of the second image centered at the coordinates x, y.

The flip operation circuitry 110 generates third characterization data 126 based on the first characterization data 122 and generates fourth characterization data 128 based on the second characterization data 124. The third characterization data 126 may include the first plurality of values in a third order, and the fourth characterization data 128 may include the second plurality of values in a fourth order. The third order may be a reverse order of the first order, and the fourth order may be a reverse order of the second order. To illustrate, if the first characterization data 122 includes a first vector [1, 2, 3], the third characterization data 126 may include a second vector [3, 2, 1]. Thus, the third characterization data 126 may be a “flipped” version of the first characterization data 122, and the fourth characterization data 128 may be a “flipped” version of the second characterization data 124. Accordingly, the third characterization data 126 may characterize a mirrored version of the first face or image and the fourth characterization data 128 may characterize a mirrored version of the second face or image.

The similarity operation circuitry 112 receives the first characterization data 122, the second characterization data 124, the third characterization data 126, and the fourth characterization data 128. The similarity operation circuitry 112 may perform one or more similarity operations using the first characterization data 122, the second characterization data 124, the third characterization data 126, and the fourth characterization data 128. For example, the similarity operation circuitry 112 may perform a first similarity operation 130 using the first characterization data 122, the second characterization data 124, the third characterization data 126, and the fourth characterization data 128 to generate first result data 134. Additionally or alternatively, the similarity operation circuitry 112 may perform a second similarity operation 132 using the first characterization data 122, the second characterization data 124, the third characterization data 126, and the fourth characterization data 128 to generate second result data 136.

In particular examples, the first similarity operation 130 and the second similarity operation 132 are different element-wise operations. For example, the first similarity operation 130 may be an absolute difference operation, and the second similarity operation 132 may be an element-wise multiplication operation, as described further herein.

The similarity operation circuitry 112 may perform the first similarity operation 130 (e.g., element-wise difference) to generate a first vector included in the first result data 134 and designated as r. Each element, rᵢ, of the vector r may be equal to “|aᵢ−bᵢ|+|Faᵢ−Fbᵢ|+|Faᵢ−bᵢ+|aᵢ−Fbᵢ|”, where a is a first vector included in the first characterization data 122, b is second vector included in the second characterization data 124, Fa is a third vector included in the third characterization data 126, Fb is a fourth vector included in fourth characterization data 128, and i is a value index. For example, aᵢ indicates the ith element (or value) of a. As used herein, |x| indicates the absolute value of x.

The similarity operation circuitry 112 may perform the second similarity operation 132 (e.g., element-wise multiplication) to generate a second vector included in the second result data 136 and designated s. Each element, sᵢ, of the vectors may be equal to “aᵢ*bᵢ+Faᵢ*Fbᵢ+Faᵢ*bᵢ+aᵢ*Fbᵢ”, where a is a first vector included in the first characterization data 122, b is second vector included in the second characterization data 124, Fa is a third vector included in the third characterization data 126, Fb is a fourth vector included in fourth characterization data 128, and i is a value index. As used herein, “*” indicates a multiplication operation. Each of the first similarity operation 130 and the second operation 132 may be considered “symmetric” because they include the flipped versions Fa, Fb of the first characterization data and the second characterization data. By including the flipped versions Fa, Fb, the first and second similarity operations account for situations where a mirror image of a face or only a partial face (e.g., a profile view) is detected in an image.

The combiner 114 receives the first result data 134 and the second result data 136 from the similarity operation circuitry 112. The combiner 114 is configured to combine the first result data 134 and the second result data 136 to generate similarity result data 138. In some examples, the similarity result data 138 includes a concatenation of the first result data 134 and the second result data 136. To illustrate, if the first result data 134 is the vector r having elements r₁, r₂, . . . rₙ, and the second result data 136 is the vectors having elements s₁, s₂, . . . sₙ, the similarity result data 138 may include a vector [r₁, . . . , rₙ, s₁, . . . sₙ]. In some examples, the combiner 114 normalizes the vector r. To illustrate, the combiner 114 may make a magnitude of the vector r equal to 1, divide a maximum value in the vector r or by a window size around the feature/landmark corresponding to the maximum value, transform the elements of the vector r using a sigmoid function (e.g., sig(s)=1/(1+e^{-s})), or a combination thereof.

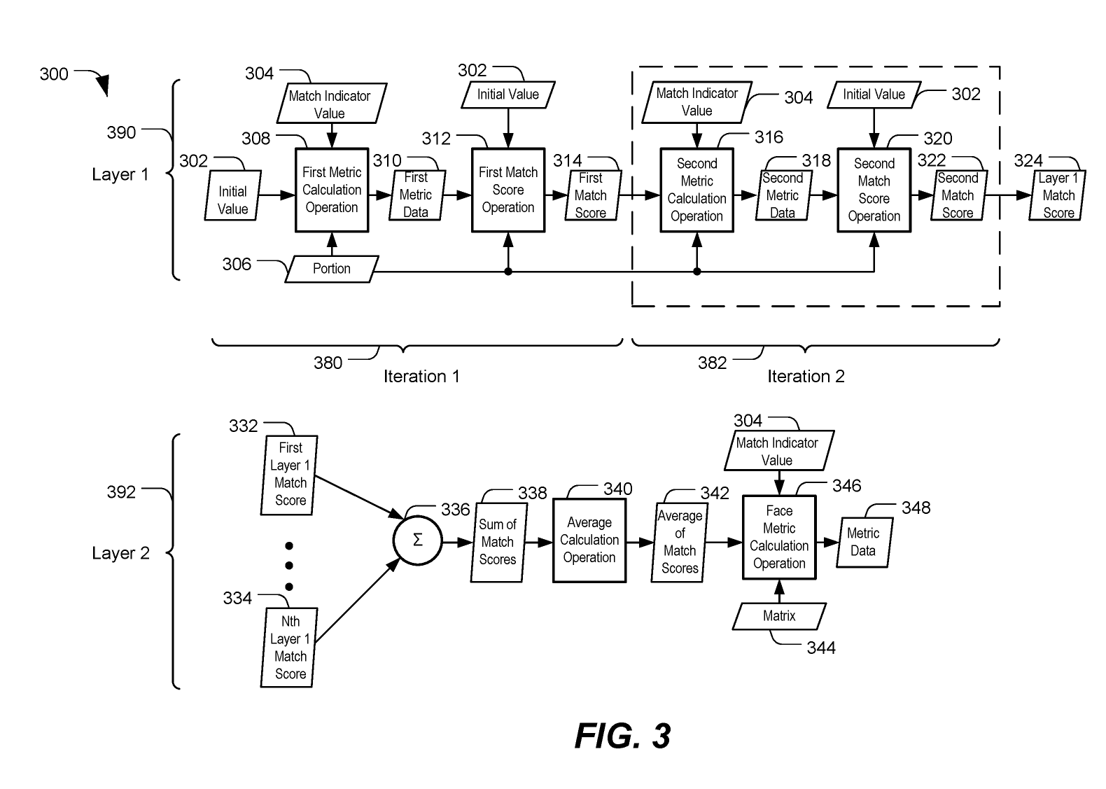

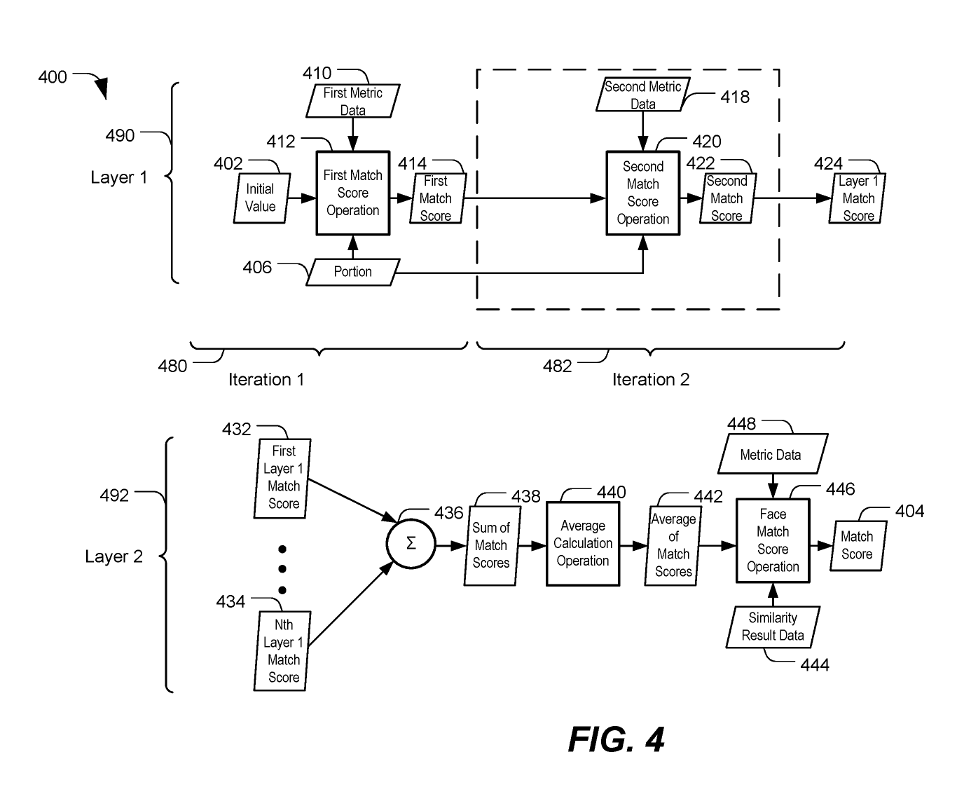

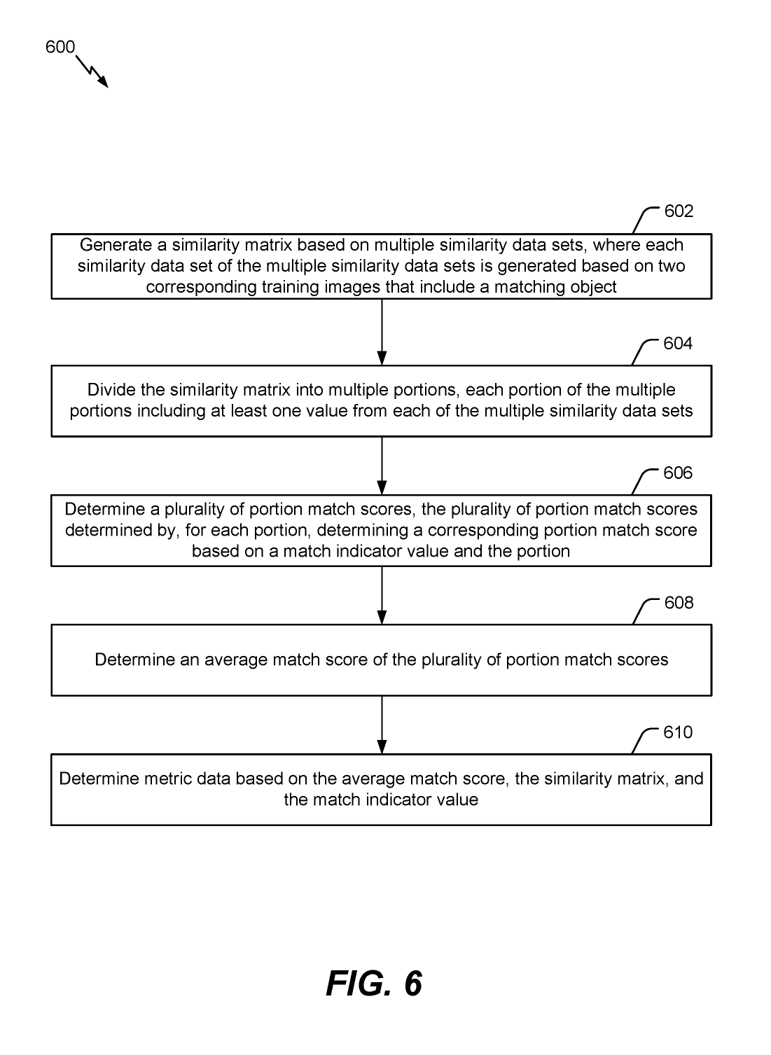

The score generator 116 determines similarity score data 140 based on the similarity result data 138 and metric data 152 stored in the memory 104. In particular examples, the similarity score data 140 is generated by the score generator 116 by means of one or more dot product operations applied to the similarity result data 138 and the metric data 152, as described further below with reference to FIG. 4. Generation of the metric data 152 is described further herein with reference to FIGS. 3 and 6.

The score comparator 118 generates match indicator data 156 by comparing the similarity score data 140 to threshold data 154 stored in the memory 104. The match indicator data 156 may indicate whether the first object (e.g., the first face) and the second object (e.g., the second face) are the same. The processor 102 may output the match indicator data 156 to another device, such as a display device or a remote device. In some implementations, the processor 102 may output the match indicator data 156 to the memory 104 for storage.

Thus, the system 100 may determine whether two images include representations of the same object (e.g., a human face). By considering mirrored versions of characterization data to compute similarity data, the system 100 may more accurately identify two images as including representations of the same face when the face is displayed in different orientations, as compared to other techniques. In addition, generating the similarity data using element-wise functions may be faster than other techniques. It is to be noted that while FIG. 1 illustrates the similarity operation circuitry 112 performing both the first similarity operation 130 to generate the first result data 134 and the second similarity operation 132 to generate the second result data 136, in some embodiments the similarity operation circuitry 112 may perform only one of the first similarity operation 130 and the second similarity operation 132. Accordingly, the processor 102 may not include the combiner 114, and the score generator 116 may generate the similarity score data 140 based on the first result data 134 or based on the second result data 136.

In the aspects of the system 100 described above, various functions performed have been described as being performed by certain circuitry or components of the system 100 of FIG. 1. However, this division of circuitry and components is for illustration only. In alternative examples, a function performed by a particular circuit or component may instead be divided amongst multiple circuits or components. Moreover, in other alternative examples, two or more circuits or components of the system 100 may be integrated into a single circuit or component. Each circuit and component illustrated in FIG. 1 may be implemented using hardware (e.g., an application-specific integrated circuit (ASIC), a processing unit such as a central processing unit (CPU), a digital signal processor (DSP), a controller, another hardware device, a firmware device, or any combination thereof).

Referring to FIG. 2, a diagram is shown illustrating a process 200 of object verification. The process 200 may be performed by a computing device, such as a device that includes the processor 102. The process 200 includes determining regions of interest in a first image 202, at 206. The first image 202 may include a representation of a first object (e.g., a first face). In particular examples, regions of interest may include landmarks identified in an image or subdivisions (e.g., patches) of the image. For example, the regions of interest may include landmarks in the representation of the first object. To illustrate, determining the regions of interest in the first image 202 may include identifying a nose, a left eye, a right eye, a mouth, etc., of the first face. In an alternative example, the regions of interest may include portions (e.g., patches) of the first image 202. To illustrate, determining the regions of interest in the first image 202 may include subdividing the first image 202 into a plurality of patches.

The process 200 further includes determining first characterization data associated with the regions of interest in the first image 202, at 210. The first characterization data may correspond to the first characterization data 122 of FIG. 1. The first characterization data may include one or more values associated with each region of interest in the first image 202. For example, the first characterization data may include a feature vector. Each element of the vector may characterize a region of interest. To illustrate, an element of the vector may indicate a direction of a wrinkle, a size of an eye, a value indicating color, a value indicating pixel intensity, or any other descriptive value.

The process 200 further includes determining regions of interest in a second image 204, at 208. The process 200 further includes determining second characterization data associated with the regions of interest in the second image 204, at 212. The second characterization data may correspond to the second characterization data 124 of FIG. 1.

The process 200 further includes determining similarity result data based on the first characterization data and the second characterization data, at 214. For example, the similarity result data may correspond to the similarity result data 138 of FIG. 1. The similarity data may be determined based on the first characterization data, the second characterization data, and flipped versions of one or both the first characterization data and the second characterization data. In particular examples, the similarity data may be determined based on one or more element-wise functions applied to the first characterization data, the second characterization data, and the flipped versions of the first characterization data and the second characterization data. For example, the similarity result data may be generated as described with reference to the similarity result data 138 of FIG. 1.

The process 200 further includes applying metric data to the similarity results data, at 216. The metric data may correspond to the metric data 152 of FIG. 1. In a particular example, the process includes determining similarity score data (e.g., the similarity score data 140 of FIG. 1) by determining one or more dot product operations between the similarity result data and the metric data.

The process 200 further includes determining whether the first object (e.g., the first face) matches the second object (e.g., the second face) based on the similarity score data, at 218. For example, the similarity score data may be compared to a threshold (e.g., the threshold data 154 of FIG. 1). In response to the similarity score data satisfying the threshold, the process 200 may result in determining that the first object matches the second object. Thus, the process 200 may be used to verify objects in two images.

Referring to FIG. 3, a diagram of a process 300 for determining metric data, such as the metric data 152, is shown. The process 300 may include a multi-layer quasi-gradient boost process. The process 300 includes a first layer 390 and a second layer 392. The process 300 may be performed at a computing device, such as a device that includes the processor 102. The process 300 may be performed using a plurality of similarity data sets. Each of the plurality of similarity data sets may be generated based on two corresponding training images that include a matching object (e.g., a matching face). In an illustrative example, a similarity data set may be calculated in the same manner as the similarity result data 138. In some examples, each similarity data set is generated using images of the same object (e.g., face). In other examples, each similarity set corresponds to images of a different object (e.g., face). For example, a first similarity data set may be generated using two images of a first face, and a second similarity data set may be generated using two images of a second face.

The plurality of similarity data sets may be arranged in a similarity matrix 344. Each row or column of the similarity matrix 344 may correspond to one of the plurality of similarity data sets. The similarity matrix 344 may be divided into multiple portions, where each portion includes at least one value from each of the multiple similarity data sets. To illustrate, the similarity matrix may be divided into one or more portions, where each element in the portion is a value associated with a particular region of interest (e.g., a portion of a face a portion of an image). The first layer 390 of the process 300 may be performed on each of the multiple portions of the similarity matrix 344. In a particular example, each column of the similarity matrix 344 corresponds to a data set of the plurality of data sets. Each portion of the multiple portions may include one or more rows of the similarity matrix 344.

The first layer 390 includes performing a first metric calculation operation 308 to derive first metric data 310 using a portion 306 of the similarity matrix, an initial value 302, and a match indicator value 304. The initial value 302 and the match indicator value 304 may correspond to values indicating whether two images include the same object. The initial value 302 may be a value indicating uncertainty (e.g., 0). The match indicator value 304 may be a value indicating a positive result (e.g., 1) because each of the similarity data sets was generated using two images of the same object. For example, the first metric calculation operation 308 may include solving for γₖ and

$$[ \begin{matrix}{b}_{k} \\ {A}_{k}\end{matrix} ]$$

in the equation

$${L}_{k + 1} ( S ) = {L}_{k} ( S ) + {γ}_{k} \cdot [ \begin{matrix}1 & S\end{matrix} ] \cdot [ \begin{matrix}{b}_{k} \\ {A}_{k}\end{matrix} ] ,$$

where Lₖ₊₁(S) corresponds to the match indicator value 304, Lₖ(S) corresponds to the initial value 302, S is the portion 306 of the similarity matrix, k is an iteration counter, γₖ is a multiplier, bₖ is a bias term, and Aₖ is a mapping function. The values γₖ, bₖ, and Aₖ may correspond to the first metric data 310. Solving for bₖ and Aₖ may include solving min_{A}_{ₖ}_{,b}_{ₖ}

$$f ( {L}_{k} ) = {min}_{{A}_{k} , {b}_{k}} ‖ Δ {L}_{k} - [ \begin{matrix}1 & S\end{matrix} ] \cdot [ \begin{matrix}{b}_{k} \\ {A}_{k}\end{matrix} ] {‖}_{2}^{2} .$$

In some examples, a partial least squares regression (PLSR) is used to solve for bₖ and Aₖ. Solving for γₖ may include performing a line search to identify a γₖ such that

$$( {L}_{k} + {γ}_{k} \cdot [ \begin{matrix}1 & S\end{matrix} ] \cdot [ \begin{matrix}{b}_{k} \\ {A}_{k}\end{matrix} ] ) \leq f ( {L}_{k} ) + {c}_{1} \cdot {γ}_{k} \cdot [ \begin{matrix}{b}_{k}^{′} & {A}_{k}^{′}\end{matrix} ] \cdot [ \begin{matrix}1 \\ {S}^{′}\end{matrix} ] \cdot ∇ f ( {L}_{k} ) \vert [ \begin{matrix}{b}_{k}^{′} & {A}_{k}^{′}\end{matrix} ] \cdot [ \begin{matrix}1 \\ {S}^{′}\end{matrix} ] \cdot ∇ f ( {L}_{k} + {γ}_{k} \cdot [ \begin{matrix}1 & S\end{matrix} ] \cdot [ \begin{matrix}{b}_{k} \\ {A}_{k}\end{matrix} ] ) \vert \leq {c}_{2} \cdot \vert [ \begin{matrix}{b}_{k}^{′} & {A}_{k}^{′}\end{matrix} ] \cdot [ \begin{matrix}1 \\ {S}^{′}\end{matrix} ] \cdot ∇ f ( {L}_{k} ) \vert ,$$

where c₁ is a first constant, c₂ is a second constant, and ∇f is a gradient function.

Once the first metric data 310 has been determined, a first match score operation 312 may be performed to determine a first match score 314 using the first metric data 310, the initial value 302, and the portion 306. Determining the first match score 314 may include solving for Lₖ₊₁(S) (e.g., the first match score 314) in the equation

$${L}_{k + 1} ( S ) = {L}_{k} ( S ) + {γ}_{k} \cdot [ \begin{matrix}1 & S\end{matrix} ] \cdot [ \begin{matrix}{b}_{k} \\ {A}_{k}\end{matrix} ]$$

where Lₖ(S)is the initial value 302 and the values of γₖ and

$$[ \begin{matrix}{b}_{k} \\ {A}_{k}\end{matrix} ]$$

correspond to the first metric data 310.

The first metric calculation operation 308 and the first match score operation 312 may correspond to a first iteration 380 of the first layer 390. In particular examples, the process 300 may include two or more iterations. In the illustrative example, a second iteration 382 is illustrated.

The second iteration 382 includes a second metric calculation operation 316 that may be performed to determine second metric data 318 based on the first match score 314, the match indicator value 304, and the portion 306. For example, the second metric calculation operation 316 may include solving for γₖ and

$$[ \begin{matrix}{b}_{k} \\ {A}_{k}\end{matrix} ]$$

(e.g., the second metric data 318) in the equation

$${L}_{k + 1} ( S ) = {L}_{k} ( S ) + {γ}_{k} \cdot [ 1 S ] \cdot [ \begin{matrix}{b}_{k} \\ {A}_{k}\end{matrix} ] ,$$

where Lₖ₊₁(S) is the match indicator value 304 and Lₖ(S) is the first match score 314. γₖ and

$$[ \begin{matrix}{b}_{k} \\ {A}_{k}\end{matrix} ]$$

may be determined as described above with reference to the first metric calculation operation 308.

The second iteration 382 further includes performing a second match score operation 320 to determine a second match score 322 based on the initial value 302, the portion 306, and the second metric data 318. Determining the second match score 322 may include solving for Lₖ₊₁(S) (e.g., the second match score 322) in the equation

$${L}_{k + 1} ( S ) = {L}_{k} ( S ) + {γ}_{k} \cdot [ 1 S ] \cdot [ \begin{matrix}{b}_{k} \\ {A}_{k}\end{matrix} ] ,$$

where Lₖ(S)is the initial value 302 and the values of γₖ and

$$[ \begin{matrix}{b}_{k} \\ {A}_{k}\end{matrix} ]$$

correspond to the second metric data 318.

In some examples, the first layer 390 may include more iterations following the second iteration 382. A match score (e.g., the second match score 322) of a final iteration (e.g., the second iteration 382) corresponds to a match score 324 of the first layer 390. The match score 324 of the first layer 390 may correspond to the region of interest that the portion 306 corresponds to. The first layer 390 may be performed on a plurality of regions of interest using a plurality of portions of the similarity matrix 344. Thus, first layer match scores, such as the match score 324, may be determined for each of the plurality of portions.

Although a single execution of the first layer 390 is shown, multiple executions of the first layer 390 may be performed resulting in multiple layer 1 match scores (e.g., the match score 324). The multiple layer 1 match scores may include a first layer 1 match score 332 to an Nth layer 1 match score 334. The second layer 392 includes generating a sum 338 by performing a summation 336 of each match score from each execution of the first layer 390. The second layer 392 further includes performing an average calculation operation 340 to determine an average 342 of match scores using the sum 338. The second layer 392 further includes performing a face metric calculation operation 346 to determine metric data 348 using the average 342, the match indicator value 304, and the similarity matrix 344. For example, the face metric calculation operation 346 may include solving for γₖ and

$$[ \begin{matrix}{b}_{k} \\ {A}_{k}\end{matrix} ]$$

(e.g., the metric data 348) in the equation

$${L}_{k + 1} ( S ) = {L}_{k} ( S ) + {γ}_{k} \cdot [ 1 S ] \cdot [ \begin{matrix}{b}_{k} \\ {A}_{k}\end{matrix} ] ,$$

where Lₖ₊₁(S) is the match indicator value 304 and Lₖ(S) is the average 342. The values of γₖ and

$$[ \begin{matrix}{b}_{k} \\ {A}_{k}\end{matrix} ]$$

may be determined as described above with reference to the first metric calculation operation 308. The metric data 348 may correspond to the metric data 152.

Thus, the process 300 of FIG. 3 may be used to determine metric data that may be used for object verification. The process 300 may include multiple layers. In the first layer 390, match scores for multiple different portions of faces or images are calculated. In the second layer 392, the match scores are averaged and used to determine metrics for a whole face. This multi-layer process may be faster and or more accurate than other processes of determining metric data.

Referring to FIG. 4, a diagram illustrating a process of generating similarity score data, such as the similarity score data 140, is designated 400. The process 400 may include a multi-layer quasi-gradient boost process. For ease of explanation, the process 400 is divided into a first processing layer 490 and a second processing layer 492. The process 400 may be performed at a computing device, such as a device that includes the processor 102. The process 400 may be performed using similarity result data 444, such as the similarity result data 138. In some examples, the similarity result data 444 may be arranged in a vector.

The similarity result data 444 may be divided into multiple portions, where each portion includes at least one value. To illustrate, the similarity result data 444 may be divided into one or more portions, where each element in the portion is a value associated with a particular region of interest (e.g., a portion of a face a portion of an image). For example, a first portion of the similarity result data 444 may include an element that indicates similarity between left eyes detected in two images, and a second portion of the similarity result data 444 may include an element that indicates similarity between right eyes detected in two images. Each portion of the multiple portions may include one or more elements of the similarity result data 444.

The first processing layer 490 of the process 400 may be performed on each of the multiple portions of the similarity result data 444. The first processing layer 490 includes performing a first match score operation 412 to determine a first match score 414 using first metric data 410, an initial value 402, and a portion 406 of the multiple portions of the similarity result data 444. Determining the first match score 414 may include solving for Lₖ₊₁(S) (e.g., the first match score 414) in the equation: Lₖ₊₁(S)=

$${L}_{k} ( S ) + {γ}_{k} \cdot [ 1 S ] \cdot [ \begin{matrix}{b}_{k} \\ {A}_{k}\end{matrix} ] ,$$

where k=1 (e.g., the first iteration), Lₖ(S)is the initial value 402, the values of γₖ and

$$[ \begin{matrix}{b}_{k} \\ {A}_{k}\end{matrix} ]$$

(e.g., for the first iteration) correspond to the first metric data 410, and S is the portion 406. The initial value 402 may indicate that whether two images include the same face is uncertain. To illustrate, the initial value 402 may equal 0 if −1 indicates the two images do not include the same face and 1 indicates that the two images do include the same face. The first metric data 410 may correspond to the first metric data 310, as described with reference to FIG. 3. The portion 406 may correspond to the portion 306. For example, the portion 406 and the portion 306 may be associated with the same part of an object or an image. To illustrate, the portion 306 and the portion 406 may each indicate similarities between left eyes.

A second iteration 482 includes performing a second match score operation 420 to determine a second match score 422 based on the first match score 414, the portion 406, and second metric data 418. Determining the second match score 422 may include solving for Lₖ₊₁(S) (e.g., the second match score 422) in the equation

$${L}_{k + 1} ( S ) = {L}_{k} ( S ) + {γ}_{k} \cdot [ 1 S ] \cdot [ \begin{matrix}{b}_{k} \\ {A}_{k}\end{matrix} ] ,$$

where k=2 (e.g., the second iteration), Lₖ(S)is the first match score 414, the values of γₖ and

$$[ \begin{matrix}{b}_{k} \\ {A}_{k}\end{matrix} ]$$

(e.g., for the second iteration, k=2) correspond to the second metric data 418, and S is the portion 406. The second metric data 418 may correspond to the second metric data 318 of FIG. 3. In alternative examples, the second metric data 418 may correspond to the first metric data 318 of FIG. 3.

A match score (e.g., the second match score 422) of a final iteration (e.g., the second iteration 482) corresponds to a match score 424 of the first processing layer 490. The match score 424 of the first processing layer 490 may correspond to the region of interest associated with the portion 406.

In some examples, the first processing layer 490 may include one or more additional iterations following the second iteration 482. In particular examples, the process 400 may include two or more iterations. Alternatively, the first processing layer 490 may include a single iteration.

The first processing layer 490 may be performed on a plurality of regions of interest using a plurality of portions of the similarity result data 444. Thus, for each of the plurality of portions, a corresponding first layer match score, such as the match score 424, may be determined. Although a single execution of the first processing layer 490 is shown, multiple executions of the first processing layer 490 may be performed resulting in multiple layer 1 match scores (e.g., the match score 424). The multiple layer 1 match scores may include a first layer 1 match score 432 to an Nth layer 1 match score 434.

The second layer 492 includes generating a sum 438 by performing a summation 436 of each portion's layer 1 match score from the first processing layer 490. The second layer 492 further includes performing an average calculation operation 440 to determine an average 442 of match scores using the sum 438.

The second layer 492 further includes performing a face match score operation 446 to determine a match score 404 using metric data 448, the average 342, and the similarity result data 444. For example, the face match score operation 446 may include solving for Lₖ₊₁(S) (e.g., the match score 404) in the equation

$${L}_{k + 1} ( S ) = {L}_{k} ( S ) + {γ}_{k} \cdot [ 1 S ] \cdot [ \begin{matrix}{b}_{k} \\ {A}_{k}\end{matrix} ] ,$$

where k=1 (e.g., a first iteration of the second layer 492), γₖ and

$$[ \begin{matrix}{b}_{k} \\ {A}_{k}\end{matrix} ]$$

correspond to the metric data 448 (e.g., metric data associated with an entire object or image), Lₖ(S) is the average 442, and S is the similarity result data 444. The metric data 448 may correspond to the metric data 348 of FIG. 3. The match score 404 may correspond to the similarity score data 140. In some examples, more than one iteration of the second layer 492 may be performed to generate the match score 404. In some examples, the match score 404 may be compared (e.g., by a processor) to a threshold. In response to the match score 404 satisfying the threshold, two images may be determined (e.g., by a processor) to include an image of the same object.

Thus, the process 400 of FIG. 4 may be used to determine similarity score data that may be used for object verification. The process 400 may include multiple layers. In the first processing layer 490, match scores (e.g., similarity score data) for multiple different portions of faces or images are calculated. In the second layer 492, the match scores are averaged and used to determine a match score for a whole face. This multi-layer process may be faster and or more accurate than other processes of determining similarity score data.

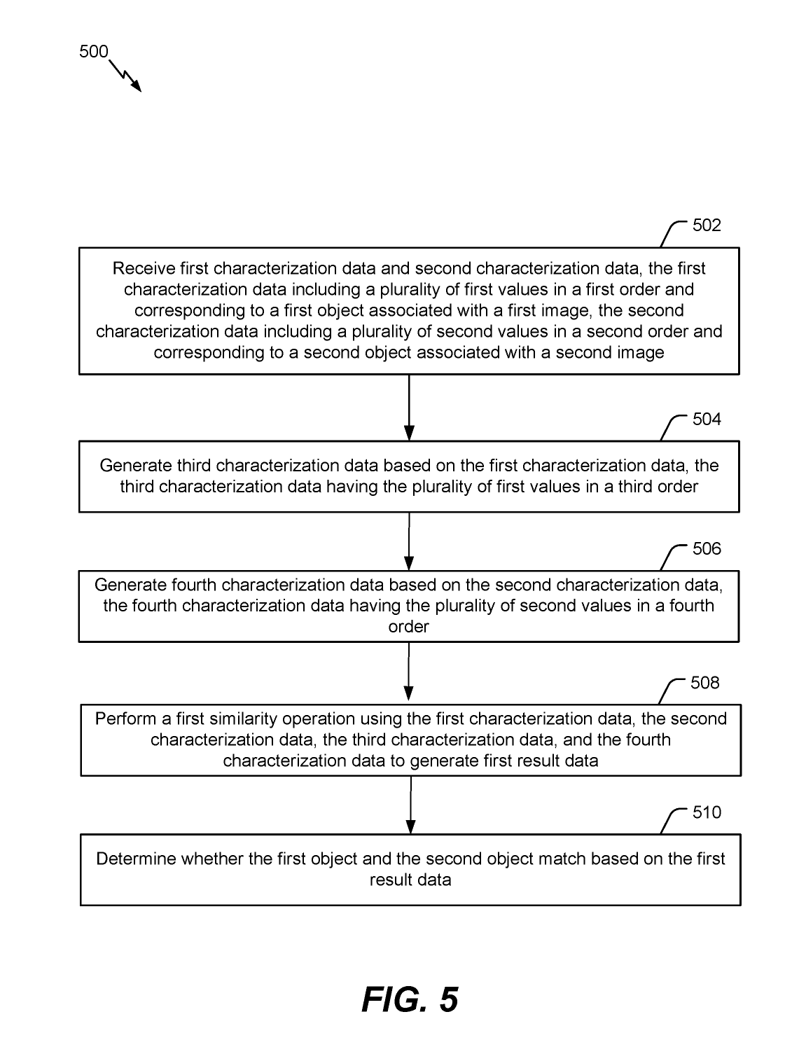

Referring to FIG. 5, a flow chart of a particular illustrative example of a method 500 of generating metric data is disclosed. The method 500 may be performed by the system 100 (e.g., the processor 102) of FIG. 1.

The method 500 includes receiving first characterization data and second characterization data, at 502. The first characterization data includes a plurality of first values in a first order and corresponding to a first object associated with a first image. The second characterization data includes a plurality of second values in a second order and corresponding to a second object associated with a second image. For example, the first characterization data and the second characterization data may include or correspond to the first characterization data 122 and the second characterization data 124, respectively, of FIG. 1.

In some implementations, the first characterization data includes first feature values associated with landmarks of the first object. The first object may include or correspond to a face, such as a face of a person. The landmarks may include a nose, a mouth, a right eye, a left eye, a chin, or a combination thereof. Additionally or alternatively, the second characterization data includes second feature values associated with the landmarks of the second object. The second object may include a second face, such as a face of a person.

In other implementations, the first characterization data corresponds to a first set of overlapping patches of the first image. Additionally or alternatively, the second characterization data may correspond to a second set of overlapping patches of the second image.

The method 500 includes generating third characterization data based on the first characterization data, the third characterization data having the plurality of first values in a third order, at 504. For example, the third characterization data may include or correspond to the third characterization data 126 of FIG. 1.

The method 500 includes generating fourth characterization data based on the second characterization data, the fourth characterization data having the plurality of second values in a fourth order, at 506. For example, the fourth characterization data may include or correspond to the fourth characterization data 128 of FIG. 1.

The method 500 includes performing a first similarity operation using the first characterization data, the second characterization data, the third characterization data, and the fourth characterization data to generate first result data, at 508. For example, the first similarity operation may include or correspond to the first similarity operation 130 or the second similarity operation 132 of FIG. 1. The first result data may include or correspond to the first result data 134 or the second result data 136 of FIG. 1.

The method 500 further includes determining whether the first object and the second object match based on the first result data, at 510. For example, referring to FIG. 1, the score generator 116 may determine the similarity score data 140 and the score comparator 118 may generate the match indicator data 156. In some implementations, the method 500 may include outputting an indication, such as the match indicator data 156, that the first object matches the second object.

In some implementations, determining whether the first object and the second object match based on the first result data (e.g., the first result data 134) includes dividing the first result data (or similarity data generated based on the first result data, such as the similarity score data 140) into portions. Each portion may include values indicating similarities between corresponding landmarks in two images or between corresponding patches in two images. The method 500 may include generating (e.g., in a first iteration of the first processing layer 490) a first score (e.g., the first layer 1 match score 432) based on a first portion (e.g., the portion 406) of the portions and based on first metric data (e.g., the first metric data 410 and/or the second metric data 418). The first metric data may correspond to the first portion (e.g., may be associated with the same landmark or patch). The method 500 may further include generating (e.g., in a second iteration of the first processing layer 490) a second score (e.g., the Nth layer 1 match score 434) based on a second portion of the portions and based on second metric data. The second metric data may correspond to the first portion. The method 500 may further include averaging the first score and the second score to determine an average score (e.g., the average 442). The method 500 may further include determining an object result (e.g., the match score 404) based on the average score, based on metric data (e.g., the metric data 448) associated with a whole object or a whole image, and based on the first similarity data (or the similarity data generated based on the first similarity data). The method 500 may further include comparing the object result to a threshold to determine whether the first object matches the second object.

In some implementations, the method 500 may include receiving the metric data and storing the metric data at a memory. Alternatively, the method 500 may include generating the metric data and storing the generated metric data. For example, the metric data may be generated as described with reference to FIG. 6. In some implementations, the metric data may be determined using a multi-layer quasi-gradient boost process as described with reference to FIG. 3.

In some implementations, each of the first characterization data, the second characterization data, the third characterization data, and the fourth characterization data includes a vector. Additionally or alternatively, the third order is a reverse order of the first order and the fourth order is a reverse order of the second order.

In some implementations, the method 500 may include performing a second similarity operation using the first characterization data, the second characterization data, the third characterization data, and the fourth characterization data to generate second result data. In some implementations, the first operation includes an element-wise absolute difference operation and the second operation includes an element-wise multiplication operation. The method 500 may also include combining the first result data and the second result data to generate similarity data.

In some implementations, to determine whether the first object and the second object match, the method 500 may include combining the first result data and the second result data to generate similarity data. The similarity data may include a similarity vector that includes the first result data and the second result data. As an illustrative, non-limiting example, combining the first result data and the second result data comprises concatenating the first result data and the second result data to form the similarity vector.

In some implementations, to determine whether the first object and the second object match, the method 500 may include calculating one or more dot product operations between the similarity data and metric data to generate a similarity score. The method 500 may also include comparing the similarity score to a threshold. The first object and the second object are determined to be the same object based on the similarity score satisfying the threshold. For example, the similarity score satisfies the threshold when the similarity score is greater than or equal to the threshold.

The method 500 may thus enable object matching based on characterization data. By considering mirrored versions of the characterization data to compute similarity data, the method 500 may more accurately identify two images as including representations of the same object when the object is displayed in different orientations, as compared to other techniques. In addition, generating the similarity data using element-wise functions may be faster or more computationally efficient than other techniques of generating similarity data.

Referring to FIG. 6, a flow chart of a particular illustrative example of a method 600 of generating metric data is disclosed. The method 600 may be performed by the system 100 (e.g., the processor 102) of FIG. 1 or by another device distinct from the system 100.

The method 600 includes generating a similarity matrix based on multiple similarity data sets, where each similarity data set of the multiple similarity data sets is generated based on two corresponding training images that include a matching object, at 602. For example, a computing device may generate the similarity matrix 344 of FIG. 3. The similarity matrix 344 may be based on a plurality of similarity data sets. Each similarity data set may be generated using the techniques described to generate the similarity result data 138 of FIG. 1. For example, each similarity data set may be generated based on first characterization data (e.g., the first characterization data 122) corresponding to a first image and second characterization data (e.g., the second characterization data 124) corresponding to a second image. The first image and the second image may each include a representation of the same object (e.g., a particular person's face).

The method 600 includes dividing the similarity matrix into multiple portions, each portion of the multiple portions including at least one value from each of the multiple similarity data sets, at 604. For example, the similarity matrix 344 may be divided into multiple portions, including the portion 306.

The method 600 includes determining a plurality of portion match scores, the plurality of portion match scores determined by, for each portion, determining a corresponding portion match score based on a match indicator value and the portion, at 606. For example, the match score 324 may be determined based on the portion 306 and based on the match indicator value 304. The first layer 390 of the process 300 may be performed for each portion so that the first layer 390 is performed multiple times to generate the set of layer 1 match scores that includes the first layer 1 match score 332 to the Nth layer 1 match score 334. The process 300 may generate first metric data 310 and/or second metric data 318 while performing the first layer 390. The first metric data 310 and the second metric data 318 may correspond to the first metric data 410 and the second metric data 418 respectively.

The method 600 includes determining an average match score of the plurality of portion match scores, at 608. For example, the first layer 1 match score 332 to the Nth layer 1 match score 334 may be averaged to determine the average 342 of the match scores.

The method 600 further includes determining the metric data based on the average match score, the similarity matrix and the match indicator value, at 610. For example, the metric data 348 may be determined based on the similarity matrix 344, the average 342, and the match indicator value 304. The metric data may correspond to the metric data 448.

The metric data may be used by the system 100 as described with reference to FIGS. 1 and 4. The method 600 may thus enable a multi-layered approach for determining metric data used for object verification. The multi-layered approach may result in metric data that generates more accurate object verification results, as compared to other techniques. In addition or in the alternative, the multi-layered approach may generate the metric data more quickly or more efficiently, as compared to other techniques for generating metric data.

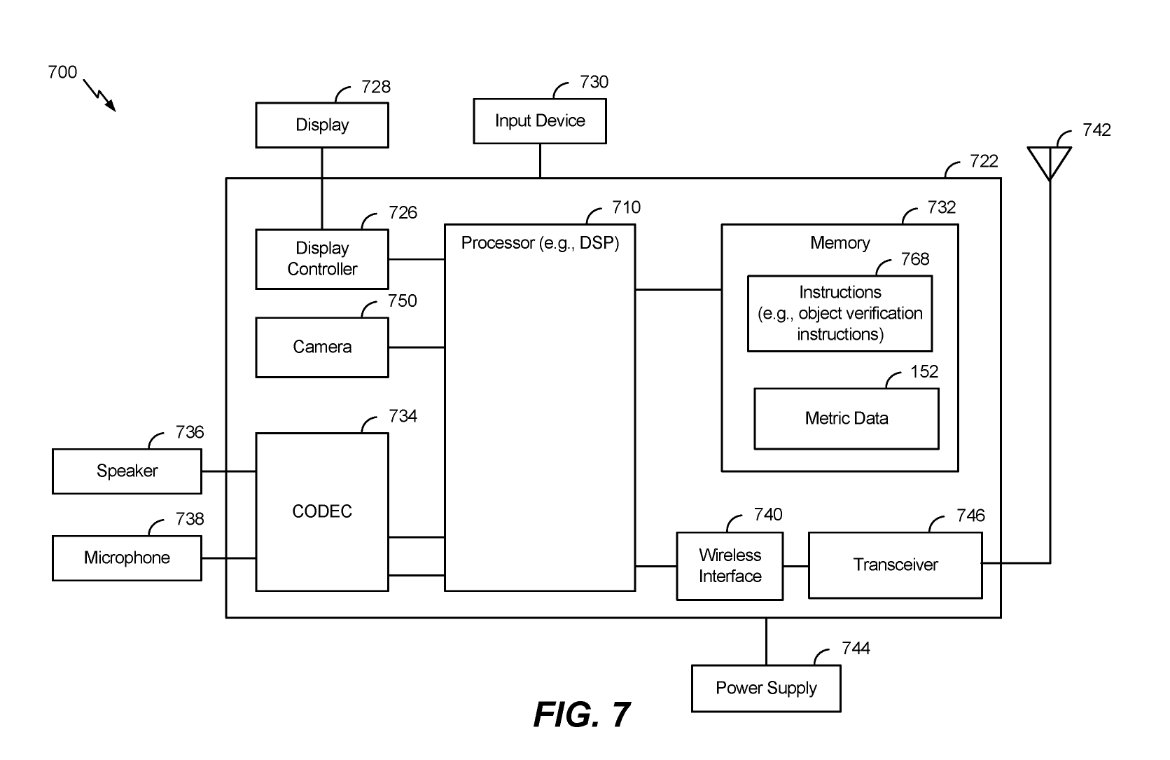

In particular aspects, the method 500 of FIG. 5, the method 600 of FIG. 6, or both may be implemented by a field-programmable gate array (FPGA) device, (e.g., an ASIC, a DSP, a controller, a FPGA device, etc.), software (e.g., instructions executable by a processor, etc.), or any combination thereof. As an example, one or more of the process 200 of FIG. 2, the process 300 of FIG. 3, the process 400 of FIG. 4, the method 500 of FIG. 5, or the method 600 of FIG. 6 may be performed by a processor that executes instructions, as described with respect to FIG. 7. To illustrate, a portion of the method 500 of FIG. 5 may be combined with a second portion of the method 600 of FIG. 6. Additionally, one or more operations described with reference to the process 200 of FIG. 2, the process 300 of FIG. 3, the process 400 of FIG. 4, the method 500 of FIG. 5, or the method 600 of FIG. 6 may be optional, may be performed at least partially concurrently, may be performed in a different order than shown or described, or a combination thereof.

Referring to FIG. 7, a block diagram of a particular illustrative implementation of a device (e.g., a wireless communication device) is depicted and generally designated 700. In various implementations, the device 700 may have more or fewer components than illustrated in FIG. 7.

In a particular implementation, the device 700 includes a processor 710, such as a central processing unit (CPU) or a digital signal processor (DSP), coupled to a memory 732. The memory 732 may include a computer-readable storage medium. For example, the memory 732 may be a non-transitory computer-readable storage medium. The memory 732 includes instructions 768 (e.g., object verification instructions) such as computer-readable instructions or processor-readable instructions. The processor 710 may correspond to the processor 102 of FIG. 1. The memory 732 may correspond to the memory 104. The instructions 768 may be executable by the processor 710 to perform any of the methods or operations described herein with reference to FIGS. 1-6. The instructions 768 may include one or more additional instructions that are executable by a computer. The memory 732 further stores the metric data 152.

FIG. 7 also illustrates a display controller 726 that is coupled to the processor 710 and to a display 728. A coder/decoder (CODEC) 734 may also be coupled to the processor 710. A speaker 736 and a microphone 738 may be coupled to the CODEC 734.

FIG. 7 also illustrates a camera 750 coupled to the processor 710. The camera 750 may be configured to generate image data. In some examples, the first characterization data 122 and/or the second characterization data 124 of FIG. 1 may be generated based on image data captured by the camera 750.

FIG. 7 also illustrates that a wireless interface 740, such as a wireless controller, and a transceiver 746 (e.g., a receiver and a transmitter) may be coupled to the processor 710 and to an antenna 742, such that wireless data received via the antenna 742, the transceiver 746, and the wireless interface 740 may be provided to the processor 710.

In some implementations, the processor 710, the display controller 726, the memory 732, the CODEC 734, the wireless interface 740, and the transceiver 746 are included in a system-in-package or system-on-chip device 722. In some implementations, an input device 730 and a power supply 744 are coupled to the system-on-chip device 722. Moreover, in a particular implementation, as illustrated in FIG. 7, the display 728, the input device 730, the speaker 736, the microphone 738, the antenna 742, and the power supply 744 are external to the system-on-chip device 722. In a particular implementation, each of the display 728, the input device 730, the speaker 736, the microphone 738, the antenna 742, and the power supply 744 may be coupled to a component of the system-on-chip device 722, such as an interface or a controller.

The device 700 may include a headset, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a component of a vehicle, or any combination thereof.

In an illustrative example, the processor 710 may be operable to perform all or a portion of the methods or operations described with reference to FIGS. 1-7. For example, the processor 710 may execute the instructions 768 to cause the processor 710 to receive first characterization data and second characterization data. The first characterization data includes a plurality of first values in a first order and corresponding to a first object associated with a first image. The second characterization data includes a plurality of second values in a second order and corresponding to a second object associated with a second image. The processor 710 may also execute the instructions 768 to generate third characterization data based on the first characterization data and to generate fourth characterization data based on the second characterization data. The third characterization data has the plurality of first values in a third order and the fourth characterization data has the plurality of second values in a fourth order. The processor 710 may further execute the instructions 768 to perform a first similarity operation using the first characterization data, the second characterization data, the third characterization data, and the fourth characterization data to generate first result data. The processor 710 may execute the instructions 768 to determine whether the first object and the second object match based on the first result data.

In conjunction with the described aspects, an apparatus includes means for receiving first characterization data and second characterization data. The first characterization data including a plurality of first values in a first order and corresponding to a first object associated with a first image. The second characterization data including a plurality of second values in a second order and corresponding to a second object associated with a second image. For example, the means for receiving may include or correspond to the processor 102, the memory 104, the flip operation circuitry 110, the processor 710, or a combination thereof.

The apparatus may also include means for generating third characterization data based on the first characterization data and for generating fourth characterization data based on the second characterization data. The third characterization data having the plurality of first values in a third order and the fourth characterization data having the plurality of second values in a fourth order. For example, the means for generating may include or correspond to the processor 102, the memory 104, the flip operation circuitry 110, the processor 710, or a combination thereof.

The apparatus may further include means for performing a first similarity operation using the first characterization data, the second characterization data, the third characterization data, and the fourth characterization data to generate first result data. For example, the means for performing may include or correspond to the processor 102, the memory 104, the similarity operation circuitry, the combiner 114, the processor 710, or a combination thereof.

The apparatus may also include means for determining whether the first object and the second object match based on the first result data. For example, the means for determining may include or correspond to the processor 102, the memory 104, the score generator 116, the score comparator 118, the processor 710, the memory 732, or a combination thereof.

In some implementations, the means for receiving the first characterization data and the second characterization data, the means for generating the third characterization data and for generating the fourth characterization data, the means for performing the first similarity operation, and the means for determining whether the first object and the second object match are integrated into a mobile phone, a cellular phone, a computer, a portable computer, a tuner, a radio, a satellite radio, a communication device, a modem, a portable music player, a portable digital video player, a navigation device, a personal digital assistant (PDA), a mobile location data unit, or a combination thereof.

One or more of the disclosed aspects may be implemented in a system or an apparatus, such as the device 700, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the device 700 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, a component integrated within a vehicle, any other device that includes a processor or that stores or retrieves data or computer instructions, or a combination thereof. As another illustrative, non-limiting example, the system or the apparatus may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

In the aspects of the description described above, various functions performed have been described as being performed by certain circuitry or components, such as circuitry or components of the system 100 of FIG. 1, the device 700 of FIG. 7, or a combination thereof. However, this division of circuitry and components is for illustration only. In alternative examples, a function performed by a particular circuit or component may instead be divided amongst multiple circuits or components. Moreover, in other alternative examples, two or more circuits or components of FIGS. 1 and 7 may be integrated into a single circuit or component. Each circuit and component illustrated in FIGS. 1 and 7 may be implemented using hardware (e.g., an ASIC, a DSP, a controller, a FPGA device, etc.), software (e.g., logic, modules, instructions executable by a processor, etc.), or any combination thereof.

Although one or more of FIGS. 1-7 may illustrate systems, apparatuses, or methods according to the teachings of the disclosure, the disclosure is not limited to these illustrated systems, apparatuses, or methods. One or more functions or components of any of FIGS. 1-7 as illustrated or described herein may be combined with one or more other portions of another of FIGS. 1-7. For example, one or more portions of the method 500 of FIG. 5 may be performed in combination with the method 600 of FIG. 6. Accordingly, no single implementation described herein should be construed as limiting and implementations of the disclosure may be suitably combined without departing form the teachings of the disclosure. As an example, one or more operations described with reference to FIG. 2, 3, 4, 5, or 6 may be optional, may be performed at least partially concurrently, or may be performed in a different order than shown or described.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the disclosure herein may be implemented directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. An apparatus comprising:
processor; and
a memory coupled to the processor, the memory comprising instructions that, when executed by the processor, cause the processor to:
receive first characterization data and second characterization data, the first characterization data including a plurality of first values in a first order and corresponding to a first object associated with a first image, the second characterization data including a plurality of second values in a second order and corresponding to a second object associated with a second image;
generate third characterization data based on the first characterization data, the third characterization data having the plurality of first values in a third order;
generate fourth characterization data based on the second characterization data, the fourth characterization data having the plurality of second values in a fourth order;
perform a first similarity operation using the first characterization data, the second characterization data, the third characterization data, and the fourth characterization data to generate first result data; and
determine whether the first object and the second object match based on the first result data.

2. The apparatus of claim 1, wherein the first object comprises a first face, wherein the second object comprises a second face, wherein the first characterization data comprises first feature values associated with landmarks of the first face, wherein the second characterization data comprises second feature values associated with landmarks of the second face, and wherein the landmarks of the first face and the landmarks of the second face include a nose, a mouth, a right eye, a left eye, a chin, or a combination thereof.

3. The apparatus of claim 1, wherein the first characterization data corresponds to a first set of overlapping patches of the first image, and wherein the second characterization data correspond to a second set of overlapping patches of the second image.

4. The apparatus of claim 1, wherein the metric data is determined based on a multi-layer quasi-gradient boost process.

5. The apparatus of claim 1, wherein each of the first characterization data, the second characterization data, the third characterization data, and the fourth characterization data comprises a vector, wherein the third order is a reverse order of the first order, and wherein the fourth order is a reverse order of the second order.

6. The apparatus of claim 1, wherein the processor is further configured to:
perform a second similarity operation using the first characterization data, the second characterization data, the third characterization data, and the fourth characterization data to generate second result data; and
combine the first result data and the second result data to generate similarity data.

7. The apparatus of claim 6, wherein the first operation comprises an element-wise absolute difference operation, and wherein the second operation comprises an element-wise multiplication operation.

8. The apparatus of claim 6, wherein the processor is further configured to calculate one or more dot product operations between the similarity data and metric data to generate a similarity score.

9. The apparatus of claim 8, wherein the processor is further configured to compare the similarity score to a threshold and to determine that the first object and the second object are the same object based on the similarity score satisfying the threshold.

10. The apparatus of claim 1, further comprising:
an antenna; and
a receiver coupled to the antenna and to the processor, wherein the memory, the processor, the receiver, and the antenna are integrated into a mobile communication device.

11. A method of performing object verification, the method comprising:
receiving first characterization data and second characterization data, the first characterization data including a plurality of first values in a first order and corresponding to a first object associated with a first image, the second characterization data including a plurality of second values in a second order and corresponding to a second object associated with a second image;
generating third characterization data based on the first characterization data, the third characterization data having the plurality of first values in a third order;
generating fourth characterization data based on the second characterization data, the fourth characterization data having the plurality of second values in a fourth order;
performing a first similarity operation using the first characterization data, the second characterization data, the third characterization data, and the fourth characterization data to generate first result data; and
determining whether the first object and the second object match based on the first result data.

12. The method of claim 11, further comprising determining the metric data using a multi-layer quasi-gradient boost process.

13. The method of claim 11, wherein the third order is a reverse order of the first order, and wherein the fourth order is a reverse order of the second order.

14. The method of claim 11, further comprising:
performing a second similarity operation using the first characterization data, the second characterization data, the third characterization data, and the fourth characterization data to generate second result data; and
combining the first result data and the second result data to generate similarity data.

15. The method of claim 14, wherein the similarity data comprises a similarity vector that includes the first result data and the second result data, and wherein combining the first result data and the second result data comprises concatenating the first result data and the second result data to form the similarity vector.

16. The method of claim 15, wherein the first operation comprises an element-wise absolute difference operation, and wherein the second operation comprises an element-wise multiplication operation.

17. The method of claim 14, further comprising:
calculating one or more dot product operations between the similarity data and metric data to generate a similarity score; and
comparing the similarity score to a threshold, the first object and the second object are determined to be the same object based on the similarity score satisfying the threshold.

18. The method of claim 17, wherein the similarity score satisfies the threshold when the similarity score is greater than or equal to the threshold, and further comprising outputting an indication of whether the first object matches the second object.

19. The method of claim 17, further comprising:
receiving the metric data; and
storing the metric data at a memory.

20. The method of claim 17, further comprising generating the metric data.

21. An apparatus comprising:
means for receiving first characterization data and second characterization data, the first characterization data including a plurality of first values in a first order and corresponding to a first object associated with a first image, the second characterization data including a plurality of second values in a second order and corresponding to a second object associated with a second image;
means for generating third characterization data based on the first characterization data and for generating fourth characterization data based on the second characterization data, the third characterization data having the plurality of first values in a third order, the fourth characterization data having the plurality of second values in a fourth order;
means for performing a first similarity operation using the first characterization data, the second characterization data, the third characterization data, and the fourth characterization data to generate first result data; and
means for determining whether the first object and the second object match based on the first result data.

22. The apparatus of claim 21, wherein the first object comprises a first face, wherein the second object comprises a second face, wherein the first characterization data comprises first feature values associated with landmarks of the first face, wherein the second characterization data comprises second feature values associated with the landmarks of the second face, and wherein the landmarks of the first face and the landmarks of the second face include a nose, a mouth, a right eye, a left eye, a chin, or a combination thereof.

23. The apparatus of claim 21, wherein the first characterization data corresponds to a first set of overlapping patches of the first image, and wherein the second characterization data correspond to a second set of overlapping patches of the second image.

24. The apparatus of claim 21, wherein the means for receiving the first characterization data and the second characterization data, the means for generating the third characterization data and generating the fourth characterization data, the means for performing the first similarity operation, and the means for determining are integrated into a mobile phone, a cellular phone, a computer, a portable computer, a tuner, a radio, a satellite radio, a communication device, a modem, a portable music player, a portable digital video player, a navigation device, a personal digital assistant (PDA), a mobile location data unit, or a combination thereof.

25. A non-transitory computer-readable medium comprising instructions that, when executed by a processor, cause the processor to:
receive first characterization data and second characterization data, the first characterization data including a plurality of first values in a first order and corresponding to a first object associated with a first image, the second characterization data including a plurality of second values in a second order and corresponding to a second object associated with a second image;
generate third characterization data based on the first characterization data, the third characterization data having the plurality of first values in a third order;
generate fourth characterization data based on the second characterization data, the fourth characterization data having the plurality of second values in a fourth order;
perform a first similarity operation using the first characterization data, the second characterization data, the third characterization data, and the fourth characterization data to generate first result data; and
determine whether the first object and the second object match based on the first result data.

26. The non-transitory computer-readable medium of claim 25, wherein the instructions, when executed by the processor, further cause the processor to:
perform a second similarity operation using the first characterization data, the second characterization data, the third characterization data, and the fourth characterization data to generate second result data;
combine the first result data and the second result data to generate similarity data;
calculate one or more dot product operations between the similarity data and metric data to generate a similarity score; and
compare the similarity score to a threshold, the first object and the second object are determined to be the same object based on the similarity score satisfying the threshold.

27. The non-transitory computer-readable medium of claim 26, wherein, to generate the metric data, the instructions further cause the processor to determine the metric data using a multi-layer quasi-gradient boost process.

28. The non-transitory computer-readable medium of claim 26, wherein, to generate the metric data, the instructions further cause the processor to:
generate a similarity matrix based on multiple similarity data sets, wherein each similarity data set of the multiple similarity data sets is generated based on two corresponding training images that include a matching object; and
divide the similarity matrix into multiple portions, each portion of the multiple portions including at least one value from each of the multiple similarity data sets.

29. The non-transitory computer-readable medium of claim 28, wherein the instructions, when executed by the processor, further causes the processor to determine a plurality of portion match scores, the plurality of portion match scores determined by, for each portion, determining a corresponding portion match score based on a match indicator value and the portion.

30. The non-transitory computer-readable medium of claim 29, wherein the instructions, when executed by the processor, further causes the processor to:
determine an average match score of the plurality of portion match scores; and
determine the metric data based on the average match score, the similarity matrix, and the match indicator value.
